(19) United States
(12) Patent Application Publication
(10) Pub. No.: US 2017/0032346 A1
(43) Pub. Date: Feb. 2, 2017

(54) INFORMATION PROCESSING DEVICE, INFORMATION PROCESSING METHOD, AND PROGRAM STORAGE MEDIUM

(71) Applicant: NEC Corporation, Tokyo (JP)

(72) Inventors: Tsuyoshi KATOU, Tokyo (JP); Naotaka HINAGO, Tokyo (JP)

(21) Appl. No.: 15/106,419

(22) PCT Filed: Sep. 17, 2014
(86) PCT No.: PCT/JP2014/004779

§ 371 Date: Jun. 20, 2016

(30) Foreign Application Priority Data
Dec. 27, 2013 (JP) 2013-271903

(51) Int. Cl. G06Q 20/18; G06K 7/10; G07G 3/00; G07F 17/42; G07F 9/02; G06Q 10/10; G07F 17/24

(52) U.S. Cl. CPC G06Q 20/18; G06Q 10/109; G06K 7/10722; G07F 17/24; G07F 17/42; G07F 9/026; G07G 3/006

(57) ABSTRACT

An objective of the present invention is to improve usability of an information processing device. Provided is an information processing device, includes a presence sensing unit, a manipulation sensing unit, a time measurement unit, and a notification unit. The presence sensing unit senses that a person is in the vicinity of the information processing device. The time measurement unit commences a time measurement at a prescribed timing after the presence sensing unit has sensed the presence of the person. The manipulation sensing unit senses that either a predetermined regular manipulation or irregular manipulation is executed as a first manipulation. The notification unit outputs notification information which issues a notification that a circumstance has arisen which requires confirmation, on the basis of whether there are notifications from the time measurement unit and the manipulation sensing unit.

### TECHNICAL FIELD

The present invention relates to an art for improving usability of an information processing device.

### BACKGROUND ART

Nowadays, various self-service terminals such as an automatic ticket-selling machine in a train station or an automatic fee-payment machine in a parking lot are prevailing. The self-service terminal is a terminal (information processing device) that provides a service through exchanging information with a user in such a way that the terminal has a dialog with the user, and is installed at a public space in many cases. Moreover, in the case that one self-service terminal provides various services, the user can receive a desired service out of the various services by the user's operating the self-service terminal.

PTL (Patent literature) 1 discloses an example of an art related to the self-service terminal. A device described by PTL 1 has a configuration in which a voice message or the like prompts the user to carry out the input operation in the case that a user does not carry out an input operation even when a predetermined time has elapsed since the device detects that the user stands in front of the device.

### CITATION LIST

### Patent Literature

[PTL 1] Japanese Patent Application Laid-Open Publication No. 2001-266218

### SUMMARY INVENTION

### Technical Problem

By the way, there is a case that a service provider, who provides the user with a service which uses the self-service terminal, desires to provide the user with the more attentive service. For example, there is a case that the service provider desires to quickly find a user, who takes a long time in operating the self-service terminal, and to support the user.

According to the device described by PTL 1, in the case that a user who needs the support has not carried out the input operation for the predetermined time since the user stands in front of the device, it is possible to detect the user who needs the support. However, according to the device described by PTL 1, it is impossible to detect the user who needs the support if the user who needs the support carries out the input operation before the predetermined time has not elapsed since the user stands in front of the device. That is, according to the device described by PTL 1, it is possible to detect only some users out of the users who need the support. In consideration of the above-mentioned point, inventors of the present invention think that it is necessary to improve usability of the device described by PTL 1. The above-mentioned problem may occurs not only in the so-called self-service terminal but also in a general-purpose Personal Computer (PC).

The present invention is conceived in order to solve the above-mentioned problem. That is, a primary object of the present invention is to provide an art that enables the improvement of usability of an information processing device.

### Solution to Problem

To achieve the primary object, an information processing device of the present invention includes:

a person detecting unit that detects presence of a person in a neighborhood of own device;

an operation detecting unit that detects, as a first operation, that a predetermined normal operation or a predetermined anomalous operation is carried out;

a time measuring unit that starts a time measurement at a predetermined timing after detecting presence of the person in the neighborhood of own device; and

a notification unit that outputs notification information to an external device that is communicably connected, when the normal operation is set as the first operation and this first operation is not detected before time measured by the time measuring unit reaches a predetermined first time or when the anomalous operation is set as the first operation and this first operation is detected before the time measured by the time measuring unit reaches the first time, the notification information notifying an occurrence of a status requiring a check.

An information processing method of the present invention includes:

by computer,

detecting presence of a person in a neighborhood of own device;

detecting, as a first operation, that a predetermined normal operation or a predetermined anomalous operation is carried out;

starting a time measurement at predetermined timing after detected presence of the person in the neighborhood of own device; and

outputting notification information to an external device that is communicably connected, when the normal operation is set as the first operation and this first operation is not detected before time measured reaches a predetermined first time or when the anomalous operation is set as the first operation and this first operation is detected before the time measured reaches the first time, the notification information notifying an occurrence of a status requiring a check.

A storage medium of the present invention storing a computer program that causes a computer to execute:

processing for detecting presence of a person in a neighborhood of own device;

processing for detecting, as a first operation, that a predetermined normal operation or a predetermined anomalous operation is carried out;

processing for starting a time measurement at a predetermined timing after detecting presence of the person in the neighborhood of own device; and

processing for outputting notification information to an external device that is communicably connected, when the normal operation is set as the first operation and this first operation is not detected before time measured reaches a predetermined first time or when the anomalous operation is set as the first operation and this first operation is detected before the time measured reaches the first time, the notification information notifying an occurrence of a status requiring a check.

Here, the primary object of the present invention is achieved also by the information processing method of the present invention which is related in the information processing device of the present invention. Moreover, the primary object of the present invention is achieved also by the computer program which can realize the information processing device of the present invention and the information processing method of the present invention, and the program storage medium which stores the computer program.

### Advantageous Effects of Invention

The present invention enables the improvement of the usability of information processing device.

### BRIEF DESCRIPTION OF DRAWINGS

FIG. 1 is a block diagram showing a functional configuration of an information processing device of a first exemplary embodiment according to the present invention.

FIG. 2 is a block diagram showing a simplified hardware configuration of the information processing device of the first exemplary embodiment.

FIG. 3 is a flowchart showing an exemplary process of the information processing device of the first exemplary embodiment.

FIG. 4 is a block diagram showing a functional configuration of an information processing device of a second exemplary embodiment according to the present invention.

FIG. 5 is a diagram used in explanation on an example of a work in which an operation detecting unit specifies a first operation corresponding to a service in the second exemplary embodiment.

FIG. 6 is a flowchart showing an example of a work of the information processing device in the second exemplary embodiment.

FIG. 7 is a flowchart showing an example of a work of an information processing device of a third exemplary embodiment according to the present invention.

FIG. 8 is a block diagram showing a functional configuration of an information processing device of a fourth exemplary embodiment according to the present invention.

FIG. 9 is a flowchart showing an example of a work of the information processing device in the fourth exemplary embodiment.

### DESCRIPTION OF EMBODIMENTS

Hereinafter, an exemplary embodiment according to the present invention will be described with reference to drawings.

### First Exemplary Embodiment

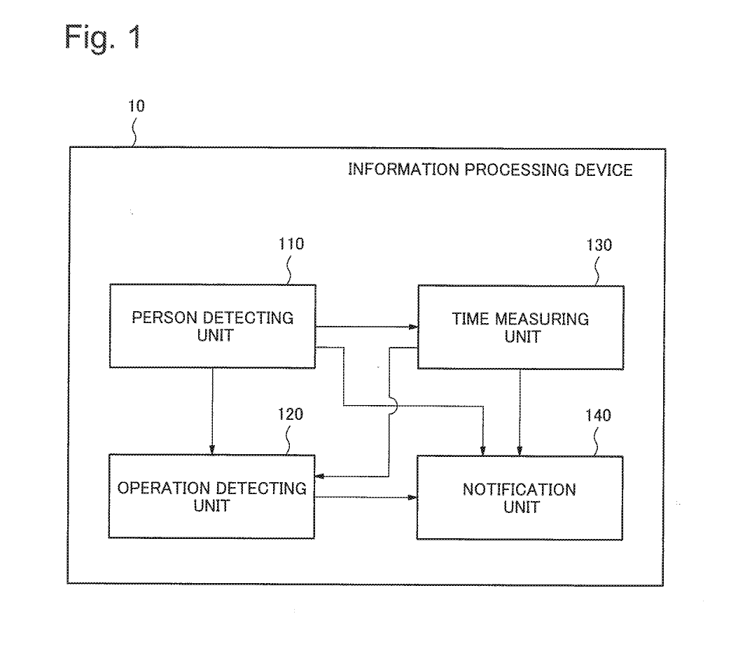

FIG. 1 is a block diagram showing a functional configuration of an information processing device in a first exemplary embodiment according to the present invention. An information processing device 10 of the first exemplary embodiment is a self-service terminal such as, for example, an automatic ticket-selling machine in a train station or an automatic fee-payment machine in a parking lot. The information processing device 10 includes a person detecting unit (person detecting means) 110, an operation detecting unit (operation detecting means) 120, a time measuring unit (time measuring means) 130 and a notification unit (notification means) 140.

The person detecting unit 110 has a function of detecting presence of a person in the neighborhood of the information processing device 10. There are many methods for detecting the presence of a person, and any one of those methods may be used. Here, the person detecting unit 110 is not limited to the use for detecting only the person. That is, the person detecting unit 110 may be used for detecting an object other than an object being always in a fixed state.

As a specific example, the person detecting unit 110 includes a sensor means such as an infrared sensor, a temperature sensor or the like, and on the basis of an output of the sensor, the person detecting unit 110 detects presence of a person in the neighborhood of the information processing device 10.

Here, in the case that the sensor means are used for detecting the person, there is a case that the person moves away from a detection range of the sensor means for a quite short time due to a change in a person's posture or the like. In this case, the sensor means do not detect the person for the quite short time though the person exists in the neighborhood of the information processing device 10. In the case of using the sensor means, in order to cope with the above-mentioned case, even if the state of the sensor means transits from a state of detecting the person to a state of not detecting the person, the person detecting unit 110 may regard that the person detecting unit 110 is in the state of detecting the person until a predetermined time elapses. The predetermined time is short like, for example, several tens millisecond to several seconds.

Moreover, the person detecting unit 110 may also use image data which is acquired from an image device such as a CCD (Charge Coupled Device) camera or the like. That is, the person detecting unit 110 carries out image processing on image data, which is acquired from the image device, by use of an algorithm for detecting a person's position or the like, and thereby detects the presence of the person in the neighborhood of the information processing device 10.

Furthermore, the person detecting unit 110 may detect the presence of the person in the neighborhood of the information processing device 10 by use of a combination of the method using the sensor and the method using the image data as mentioned above. In the case of detecting the presence of the person in the neighborhood of the information processing device 10, the person detecting unit 110 sends a notification (person detection notification), which indicates that the person is detected, to the time measuring unit 130.

The time measuring unit 130 has a function of measuring an elapse time, which starts from a point of time when the person detecting unit 110 detects the person, on the basis of the person detection notification sent from the person detecting unit 110. Specifically, the time measuring unit 130 includes, for example, a timer. The time measuring unit 130 starts measuring the time on the basis of the person detection notification which is received from the person detecting unit 110. Here, the time measuring unit 130 may start measuring the time just at a point of time when receiving the person detection notification, or may start measuring the time after a predetermined time has elapsed since the time measuring unit 130 receives the person detection notification.

The time measuring unit 130 may have only the function for measuring the time, or may, for example, further include a function for detecting that a measured time reaches a predetermined first time. Specifically, by comparing the measured time with the first time, the time measuring unit 130 determines whether the measured time reaches the first time or not. When the measured time reaches the first time, the time measuring unit 130 sends a notification (time elapse notification), which notifies that the measured time reaches the first time, to the notification unit 140.

Here, in the case that the time measuring unit 130 has only the function for measuring the time, for example, the notification unit 140 has the function for detecting that the measured time output by the time measuring unit 130 reaches the first time. In the following explanation, a case that the time measuring unit 130 detects elapse of the first time will be exemplified and described.

Moreover, while a configuration in which the time measuring unit 130 uses the timer is exemplified in the first exemplary embodiment, the time measuring unit 130 may measure (calculate) the time without using the timer. For example, the time measuring unit 130 acquires information, which indicates a time when the person detecting unit 110 detects the person, or a time after elapse of setting time from the time of detecting the person, as a measurement start time. Next, at every predetermined timing, the time measuring unit 130 may obtain a difference between a start time of measurement and a current time, and may carry out a time measuring process (time calculating process) on the basis of the difference.

Information on the first time is stored in advance, for example, in a storage unit of the information processing device 10 such as a hard disc device or a memory, or in a storage unit which is connected with the information processing device 10 so as to be able to communicate. Moreover, the information on the first time which is stored by the storage unit can be set or changed according to statistical data on status of service utilization or the like. For example, a service provider or the like, who manages the information processing device 10, sets or changes the information on the first time by use of an input device.

The operation detecting unit 120 has a function of detecting that a predetermined first operation is carried out. Moreover, the operation detecting unit 120 has a function of sending a notification (first operation detection notification), which notifies that the first operation is detected, to the notification unit 140. Here, the operation detecting unit 120 may continuously carry out the process of detecting the first operation. However, from a view point of reducing electric power consumption, it is assumed that the detection process is carried out only at a predetermined period of time. The period of time is determined, for example, on the basis of detection information output from the person detecting unit 110 and measurement information output from the time measuring unit 130. The period of time starts, for example, at a point of time when the person detecting unit 110 detects the person. The period of time ends, for example, at a point of time when elapse of the first time is detected on the basis of the measured time output from the time measuring unit 130.

Information indicating the first operation is stored in advance, for example, in a storage unit of the information processing device 10 such as a hard disc device or a memory, or in a storage unit which is connected with the information processing device 10 so as to be able to communicate. Moreover, the information indicating the first operation can be set or changed, for example, on the basis of characteristics of various services provided by the information processing device 10 or the like. For example, the service provider who manages the information processing device 10 or the like sets or changes the information indicating the first operation by use of an input device. Moreover, plural kinds of operations may be stored as the first operation. In this case, when the operation detecting unit 120 detects any one of the plural kinds of operations, the operation detecting unit 120 may regard that it is detected that the first operation is carried out.

Moreover, the operation detecting unit 120 may detect, as the first operation, an operation pattern including a plurality of operations related each other. Also in this case, information indicating the operation pattern, which is stored by the storage unit and which is regarded as the first operation, can be set or changed, for example, by the service provider, who uses an input device, on the basis of, for example, information on characteristics of various services, logs of past operation, or the like.

As a specific example of the first operation, an anomalous operation or a normal operation can be exemplified. A method of setting the normal operation as the first operation can be called a white list method, and a method of setting the anomalous operation can be called a black list method.

In the case of adopting the white list method, the first operation which the operation detecting unit 120 detects may be one operation, or may be one operation pattern including a plurality of operations which are related each other.

On the other hand, in the case of adopting the black list method, it is difficult to conceive a case that the anomalous operation is composed of only one operation. Accordingly, it is conceivable that the first operation which the operation detecting unit 120 detects is the operation pattern including plural kinds of operations.

In the case of adopting the black list method, the operation detecting unit 120 may send the first operation detection notification at timing when detecting the first operation, or may send the first operation detection notification in the following case. Here, a period from a point of time when the person detecting unit 110 detects the person to a point of time when elapse of the first time is detected on the basis of the measured time output by the time measuring unit 130 is denoted as a monitoring period. In the case that a ratio of the first operations to all operations which are carried out at the monitoring period, or the number of the first operations which are carried out is equal to or larger than a predetermined threshold, the operation detecting unit 120 may send the first operation detection notification.

In the case that the operation detecting unit 120 sends the first operation detection notification at the timing when detecting the first operation as mentioned above, the notification unit 140 can quickly detect an occurrence of a problem in the information processing device 10. Meanwhile, in the case that the operation detecting unit 120 sends the first operation detection notification on the basis of the ratio or the number of the operation patterns which are carried out, the notification unit 140 can determine more precisely whether a problem occurs at a time of using the information processing device 10.

Here, since it is difficult to set all of the anomalous operation patterns as the first operation without any oversight, in order to prevent a failure in detecting the anomalous operation, it is preferable that the first operation is set with the white list method.

The notification unit 140 outputs notification information to an external device on the basis of results of processes of the time measuring unit 130 and the operation detecting unit 120. Specifically, the notification unit 140 determines whether the notification unit 140 outputs the notification information to the external device, depending on a combination of determination results as to whether the notification unit 140 receives the time elapse notification from the time measuring unit 130 and whether the notification unit 140 receives the first operation detection notification from the operation detecting unit 120. Here, in the case the time measuring unit 130 carries out only the time measurement, the notification unit 140 compares the measured time output by the time measuring unit 130 with the first time, and uses a comparison result in place of the time elapse notification. In this case, the notification unit 140 determines whether the notification unit 140 outputs the notification information to the external device, depending on a combination of determination results as to whether the first time elapses and whether the notification unit 140 receives the first operation detection notification from the operation detecting unit 120. The external device, which is a destination of the output notification information, is connected with the information processing device 10 directly or through another device so as to be able to communicate. The external device is an installation type terminal which is used in a support desk of the service provider side, a mobile terminal which each service provider has, or the like.

Here, a monitoring status of elapse of the first time and a detecting status of the first operation indicate whether the anomalous operation is carried out to the information processing device 10. In the case that the white list method is adopted, when the first operation is not detected though the first time has elapsed, the notification unit 140 determines that the anomalous operation or an anomalous action is carried out, and then outputs the notification information. In other words, in the case that the first operation (normal operation) is detected before the first time has elapsed since when the person is detected, the notification unit 140 determines that the anomalous operation or the anomalous action is not carried out, and does not output the notification information. In the case that the white list method is adopted, as mentioned above, the normal operation which, in an usual case, should be carried out before the first time elapses is set as the first operation. As an example of the normal operation, an operation of putting a fare into an automatic ticket-selling machine within a predetermined time or the like is exemplified. Moreover, the first time is set in consideration of a period from a point of time when a user approaches the device to until which the normal operation is supposed to be carried out.

Meanwhile, in the case that the black list method is adopted, when the first operation (anomalous operation) is detected before the measured time output by the time measuring unit 130 reaches the first time, the notification unit 140 determines that the anomalous operation is carried out, and outputs the notification information. In this case, even if the first operation (anomalous operation) is detected after the measured time output by the time measuring unit 130 reaches the first time, the notification unit 140 determines that the anomalous operation is not carried out, and does not output the notification information. In the case that the black list method is adopted, the operation pattern which is the first operation includes an operation that may be considered anomalous by itself. As an example of the anomalous operation, the following is conceivable. In a certain process, after a button for proceeding to a next step is pressed, a button for returning to one step before is pressed, and the above is repeated. In the case of the above-mentioned operation, there is a possibility that the user is in a state of suffering from some problem like the user is not familiar with the operation. Accordingly, the above-mentioned operation can be set as the anomalous operation. Furthermore, in the case that the black list method is adopted, the first time is set in consideration of the period from when the user approaches the device to until which the anomalous operation is supposed to be carried out.

Moreover, the notification information which is output by the notification unit 140 is, for example, information which notifies the service provider, who uses the information processing device 10, that a status requiring a check occurs. The notification information includes, for example, information on the person who is detected by the person detecting unit 110, or information on the operation which is carried out to the information processing device 10 by the person. For example, the notification information includes a message which notifies that the anomalous operation is detected, an operation record on the operation which is carried out to the information processing device 10 by the person (user) detected by the person detecting unit 110, image data of the user which is captured by an image device, or the like. The notification information is used for improving usability of the information processing device 10 by providing the service provider side with the notification information. For example, by receiving the notification information, the service provider can grasp that some problem occurs in the information processing device 10, and can take action to cope with the problem.

Here, each function unit of the information processing device 10 depicter in FIG. 1 is realized by any combination of hardware and software whose main components are a CPU (Central Processing Unit) of a computer, a memory, a computer program (program) which is loaded in the memory, a storage medium such as a hard disc which stores the program, and an interface for network connection.

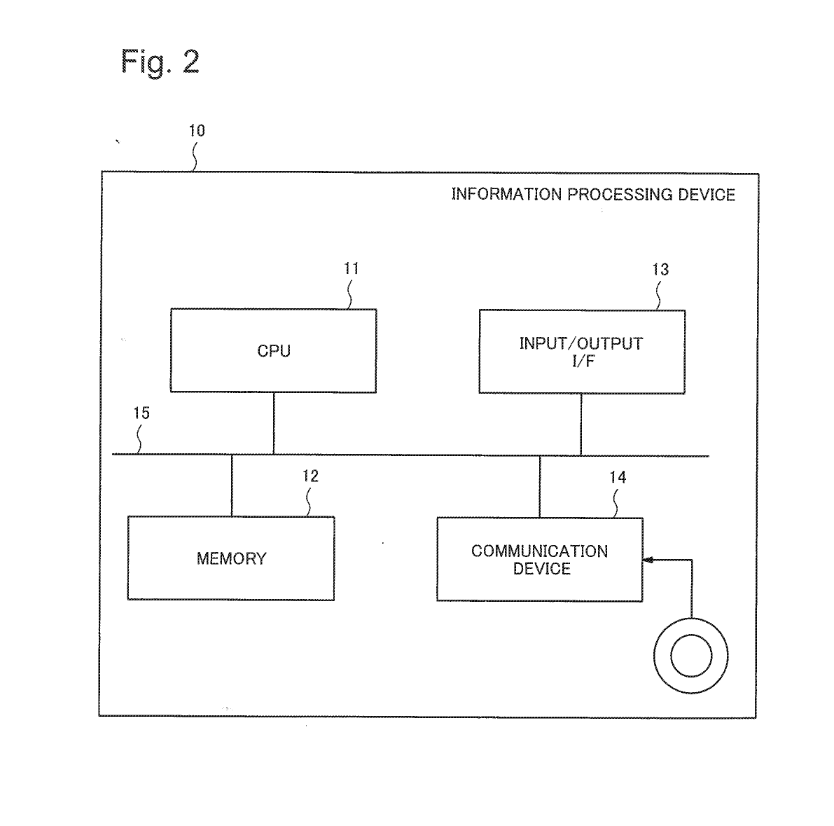

FIG. 2 is a diagram showing a simplified hardware configuration of the information processing device 10. The information processing device 10 includes, for example, a CPU 11, a memory 12, an input/output interface (I/F) 13, a communication device 14, and the like, which are interconnected with a bus 15. The memory 12 is RAM (Random Access Memory), ROM (Read Only Memory), a hard disc device, or the like. The communication device 14 is a device which has a function of communicating with another computer or device. Also a mobile type record medium or the like can connect with the communication device 14.

The input/output I/F 13 can connect with a user interface device (not shown in the figure) such as a display device, an input device or the like. The display device is a device, which displays a screen corresponding to drawing data processed by CPU 11, GPU (Graphics Processing Unit) or the like, such as LCD (Liquid Crystal Display) or CRT (Cathode Ray Tube). The input device is a device, which receives an input operation carried out by the user, such as a key board, a mouse or the like. Here, a hardware configuration of the information processing device 10 is not limited to the configuration shown in FIG. 2. For example, a key board which is connected with the information processing device 10 as the input device may be a mechanical key board or may be a software key board.

Each function unit of the information processing device 10 is implemented, for example, when the CPU 11 executes a program stored in the memory 12. For example, the program is installed from a mobile type record medium such as CD (Compact Disc), a memory card or the like, or from another computer through the communication device 14 to be stored by the memory 12.

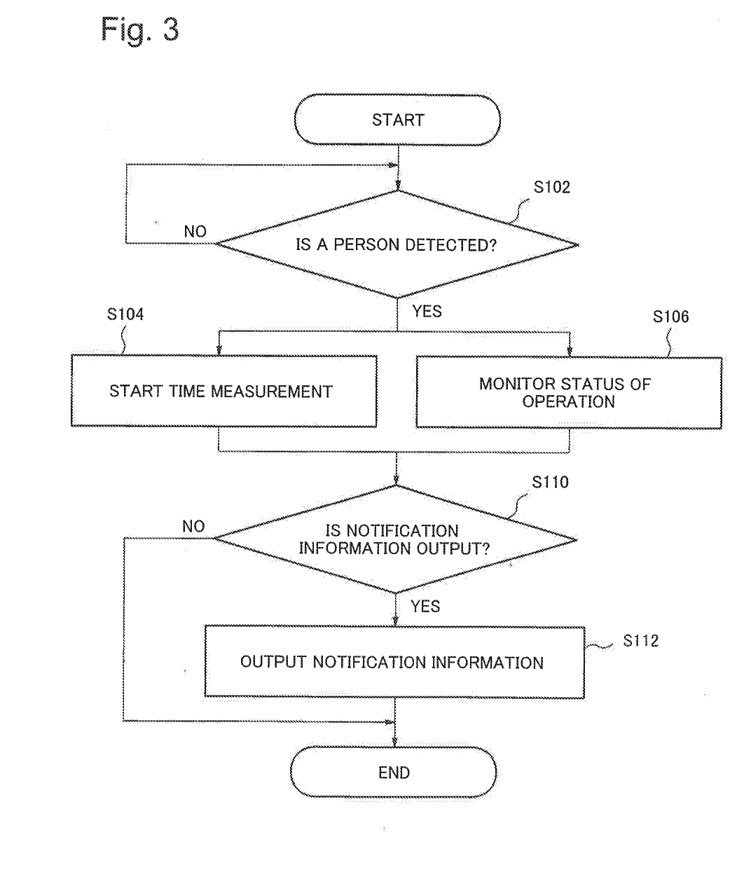

Hereinafter, an example of a process carried out by the information processing device 10 in the first exemplary embodiment will be described with reference to FIG. 3. FIG. 3 is a flowchart showing the example of the process carried out by the information processing device 10 in the first exemplary embodiment. The flowchart shows a procedure of processes which are carried out by the information processing device 10 (CPU).

Firstly, the person detecting unit 110 determines whether a person is detected in the neighborhood of the information processing device 10 (Step S102). In the case that no person is detected in the neighborhood of the information processing device 10, the person detecting unit 110 continues to carry out the processing (process) of detecting the person. On the other hand, in the case that the person is detected in the neighborhood of the information processing device 10, the person detecting unit 110 sends the person detection notification to the time measuring unit 130.

The time measuring unit 130 starts measuring the time on the basis of the person detection notification which is sent from the person detecting unit 110 (Step S104). By comparing the measured time with the first time, the time measuring unit 130 determines whether the measured time reaches the first time. In the case that the time measuring unit 130 determines that the measured time reaches the first time on the basis of the comparison result, the time measuring unit 130 sends the time elapse notification to the notification unit 140.

After the person detecting unit 110 detects the person, the operation detecting unit 120 monitors the status of the operation which is carried out to the information processing device 10 (Step S106). That is, the operation detecting unit 120 monitors whether the first operation is carried out. In the case of detecting that the first operation is carried out, the operation detecting unit 120 sends the first operation detection notification to the notification unit 140.

Then, on the basis of determination whether the notification unit 140 receives the notifications sent from the time measuring unit 130 and the operation detecting unit 120, the notification unit 140 determines whether the notification unit 140 should output the notification information (necessity of outputting) (Step S110). Specifically, in the case that the white list method is adopted, the notification unit 140 determines the necessity of outputting the notification information as follows. That is, the notification unit 140 determines that the notification information should be output in the case that the notification unit 140 does not receive the first operation detection notification from the operation detecting unit 120 at a period from a point of time when the notification unit 140 detects that the person is detected on the basis of the information output by the person detecting unit 110 to a point of time when the notification unit 140 receives the time elapse notification output by the time measuring unit 130. On the other hand, the notification unit 140 determines that the notification information should not be output in the case that the notification unit 140 receive the first operation detection notification from the operation detecting unit 120 at the period from a point of time when the person detecting unit 110 detects the person to a point of time when the notification unit 140 receives the time elapse notification from the time measuring unit 130.

In the case that the black list method is adopted, the notification unit 140 determines necessity of outputting the notification information as follows. That is, the notification unit 140 determines that the notification information should be output in the case that the notification unit 140 receive the first operation detection notification from the operation detecting unit 120 at the period from a point of time when the person detecting unit 110 detects the person to a point of time when the notification unit 140 receives the time elapse notification from the time measuring unit 130. The notification unit 140 determines that the notification information should not be output in the case that the notification unit 140 does not receive the first operation detection notification from the operation detecting unit 120 at the period from a point of time when the person detecting unit 110 detects the person to a point of time when the notification unit 140 receives the time elapse notification from the time measuring unit 130.

In the case that the notification unit 140 determines that the notification information should be output the notification information, the notification unit 140 outputs the notification information to the external device (Step S112). On the other hand, in the case that the notification unit 140 determines that the notification information should be output, the notification unit 140 ends the process without outputting the notification information.

Hereinafter, an effect which is acquired from the configuration of the first exemplary embodiment will be mentioned.

According to the first exemplary embodiment, the notification unit 140 determines that the notification information should be output on the basis of the status of the operation at the period (monitoring period) from a point of time when the person detecting unit 110 detects the person to a point of time when the measured time output by the time measuring unit 130 reaches the first time. Specifically, in the case that the white list method is adopted as the first operation setting method, when the first operation is not detected at the monitoring period, the notification unit 140 outputs the notification information. That is, the status in which the notification information is output is a status in which the user exists at a position where the user can operate the information processing device 10, and the first operation, which should be carried out in a usual case, is not carried out within the first time. In this status, it is possible that the user carries out another operation or another action which has no relation to a normal use of the device, and the operation or the action may be considered as anomalous. The information processing device 10 of the first exemplary embodiment can detect that such anomalous action or anomalous operation occurs and can output the notification information to the external device.

On the other hand, in the case that the black list method is adopted as the first operation setting method, when the first operation is detected at the monitoring period, the notification unit 140 outputs the notification information. That is, the status in which the notification information is output is a status in which the anomalous operation (anomalous action) is carried out at the monitoring period. The information processing device 10 of the first exemplary embodiment can detect that the anomalous action or the anomalous operation occurs, and can output the notification information to the external device. Here, by determining on the basis of frequency of detecting the first operation at the monitoring period or the like whether the anomalous operation is carried out, the information processing device 10 of the first exemplary embodiment can detect the anomalous operation more precisely.

The information processing device 10 of the first exemplary embodiment enable to improve the usability by outputting the notification information, which notifies that the anomalous operation is detected, to the external device as mentioned above. For example, in the case that the user is not familiar with operating the information processing device 10, the user is dismayed by the operation, and it takes a long time for the user to receive a desired service. In this case, the service provider who is familiar with the operation of the information processing device 10 can recognize such the user with ease, and can quickly support the user. That is, if there is no offer from the user, it is difficult in almost all cases for the service provider to recognize that the user is in a dismayed status. In contrast, the information processing device 10 of the first exemplary embodiment can detect the anomalous action or the anomalous operation of the user, and can output detection of the anomalous action or the anomalous operation to the external device which the service provider uses. By virtue of the above, it is possible for the service provider to recognize the dismayed service user with ease, and can quickly support the user.

Moreover, the information processing device 10 of the first exemplary embodiment can detect the anomalous operation or the like which has criminality, and can notify the service provider side of detecting the anomalous operation. As a result, the information processing device 10 can have a superior ability for preventing a crime.

Here, the notification information which the notification unit 140 in the first exemplary embodiment outputs may include an image data or the operation record. By virtue of the above, it is possible to grasp a problem on the usability of the information processing device 10 more precisely by the service provider's checking the image data or the operation record which is received.

### Second Exemplary Embodiment

Hereinafter, a second exemplary embodiment according to the present invention will be described. Here, in an explanation on the second exemplary embodiment, portions of a configuration of the second exemplary embodiment, which are the same as the ones of the first exemplary embodiment, are assigned with the same reference numerals, and explanations on the same portion are omitted.

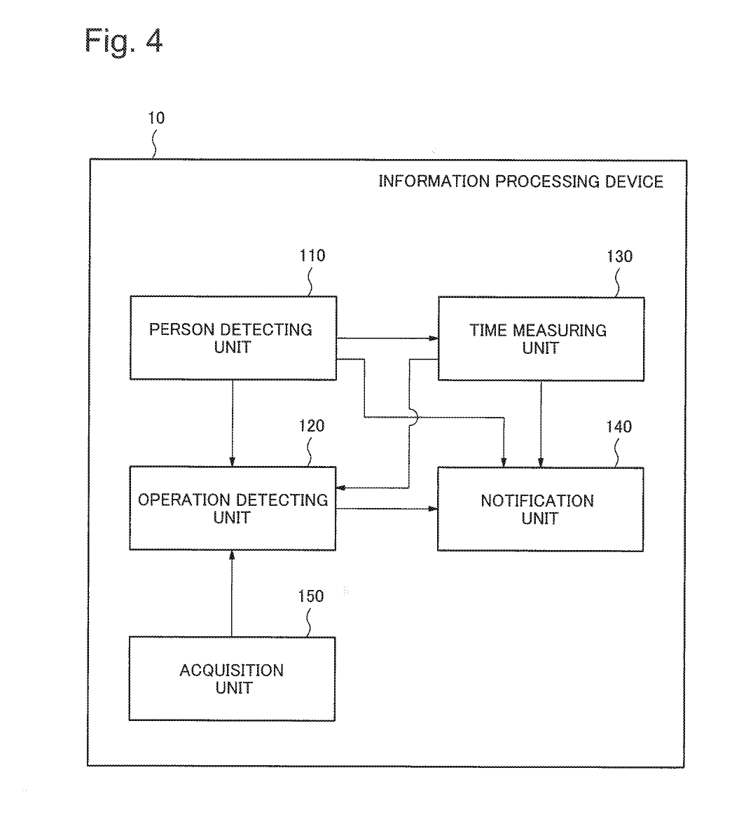

FIG. 4 is a block diagram showing a functional configuration of an information processing device in the second exemplary embodiment. The information processing device 10 of the second exemplary embodiment furthermore includes an acquisition unit (acquisition means) 150 in addition to the configuration of the first exemplary embodiment.

The acquisition unit 150 has a function of acquiring service identifying information that identifies a service carried out by the person who is detected by the person detecting unit 110. The acquisition unit 150 acquires information that enable identification of each service as the service identifying information. The information includes, for example, a service ID which is assigned to each service provided by the information processing device 10, or the like. Such a service identifying information can be acquired, for example, on the basis of identification information assigned to a button to which the user carries out an operation such as pressing the button or the like in order to start a desired service. Moreover, the acquisition unit 150 has a function of sending the acquired service identifying information to the operation detecting unit 120.

In the second exemplary embodiment, the first operation is set in advance for each of plural services. That is, the first operation assigned to each service is appropriately set, for example, in consideration of characteristic of each service, a status of actual usage, or the like. Since the first operation is set as mentioned above, in the second exemplary embodiment, the operation detecting unit 120 has a function of identifying the first operation corresponding to the service identifying information acquired by the acquisition unit 150.

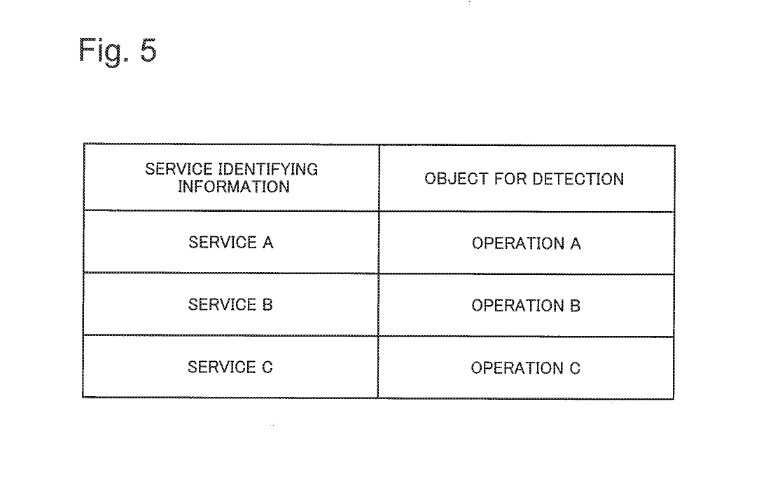

Here, a specific example of a process in which the operation detecting unit 120 identifies the first operation will be mentioned with reference to FIG. 5. It is assumed that the information processing device 10 can provide, for example, three services to which service identifying information A to C shown in FIG. 5 are assigned respectively. In this case, the information processing device 10 can use information on operations A to C which are associated with the service identifying information A to C respectively and each of which is corresponding to the first operation. The information is stored as operation specifying information, for example, by a storage unit of the information processing device 10 such as a hard disc device or a memory, or by a storage unit which is communicably connected with the information processing device 10.

When receiving the service identifying information from the acquisition unit 150, the operation detecting unit 120 reads the operation, which is corresponding to the service identifying information, from the operation specifying information as the first operation. That is, the operation detecting unit 120 identifies the first operation that corresponds to the received service identifying information. More specifically, for example, in the case of acquiring ‘service A’ as the service identifying information from the acquisition unit 150, the operation detecting unit 120 identifies ‘operation A’ from the operation specifying information as the first operation. Here, the first operation (operations A to C) is not limited to one operation, and may be the operation pattern including plural kinds of operations similarly to the mention in the first exemplary embodiment.

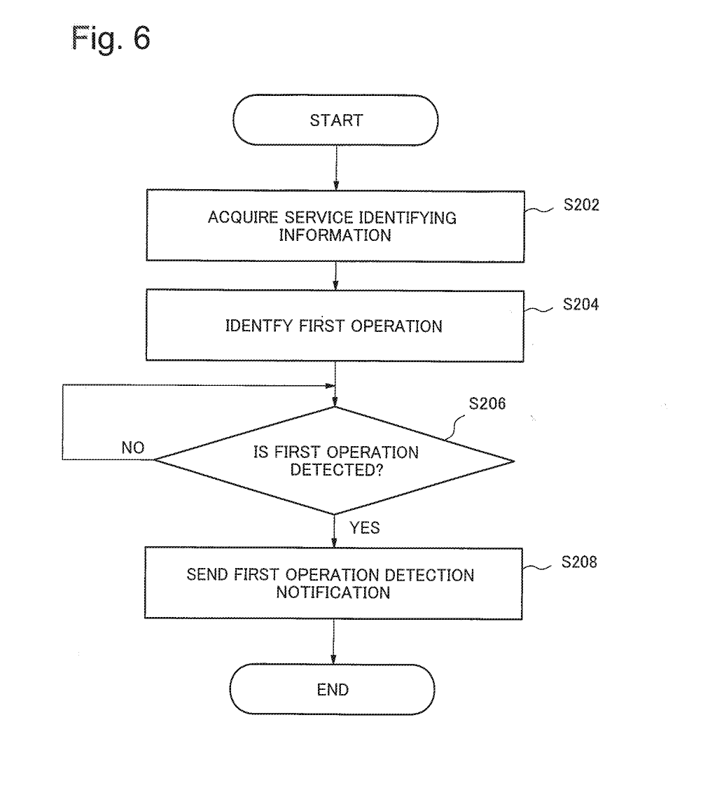

An example of a process of the information processing device 10 in the second exemplary embodiment will be described in the following with reference to FIG. 6. FIG. 6 is a flowchart showing the example of the process of the information processing device 10 in the second exemplary embodiment. The flowchart in FIG. 6 shows the process corresponding to the process (Step S106) for monitoring the status of the operation which is shown in FIG. 3 in the first exemplary embodiment. The processes of the information processing device 10 of the second exemplary embodiment other than the above mentioned process are the same as the ones in the first exemplary embodiment.

Firstly, when the acquisition unit 150 acquires the service identifying information (Step S202), the acquisition unit 150 sends the acquired service identifying information to the operation detecting unit 120.

On the basis of the service identifying information which is received from the acquisition unit 150, the operation detecting unit 120 identifies the first operation that corresponds to the service identifying information (Step S204). Next, the operation detecting unit 120 monitors the status of the operation which is carried out to the information processing device 10, and determines whether the identified first operation is carried out (Step S206). In the case of detecting that the first operation is carried out, the operation detecting unit 120 generates the operation detection notification and sends the generated operation detection notification to the notification unit 140 (Step S208). On the other hand, in the case of not detecting that the first operation is carried out, the operation detecting unit 120 continues to monitor the status of the operation which is carried out to the information processing device 10. Here, in the case of detecting that the measured time output by the time measuring unit 130 reaches the first time, the operation detecting unit 120 ends the monitoring process.

In the second exemplary embodiment, the first operation is set per the service, for example, in consideration of the characteristic of each service and the status of actual usage. Then, on the basis of the service identifying information which is acquired by the acquisition unit 150, the operation detecting unit 120 detects (specifies) the first operation that corresponds to the service, and the notification unit 140 carries out the notification process to the external device on the basis of the detection result. In the second exemplary embodiment, since it is possible to set the first operation per the service, the information processing device 10 enables to set the first operation more precisely in conformity with a status correspondingly to the service. Therefore, the information processing device 10 can further improve the usability.

### Third Exemplary Embodiment

Hereinafter, a third exemplary embodiment according to the present invention will be described. Here, in the explanation on the third exemplary embodiment, portions of a configuration of the third exemplary embodiment, which are the same as the ones of the first exemplary embodiment, are assigned with the same reference numerals, and explanations on the same portions are omitted.

The information processing device 10 of the third exemplary embodiment has the following configuration (function) in addition to the configuration (function) of the first exemplary embodiment shown in FIG. 1 or the configuration (function) of the second exemplary embodiment shown in FIG. 4

That is, in the third exemplary embodiment, the operation detecting unit 120 has a function not only to detect that the user of the information processing device 10 carries out the first operation but also to detect that the user carries out a predetermined second operation. A period of time during which the operation detecting unit 120 detects the second operation is from a point of time when the person detecting unit 110 detects presence of the person to a point of time when the first operation is detected.

Moreover, in the case of detecting that the second operation is carried out, the operation detecting unit 120 sends a notification (second operation detection notification), which notifies that the second operation is detected, to the time measuring unit 130.

Detection of the second operation relates to the time measurement which is carried out by the time measuring unit 130. Information on the second operation is stored, for example, by a storage unit of the information processing unit 10 such as a hard disc device, a memory or the like, or by an external storage unit which is communicably connected with the information processing device 10. Moreover, the second operation is not always composed of one operation, and plural kinds of operations may be stored by the storage unit as the second operation. In this case, when one of the plural kinds of operations is detected, the operation detecting unit 120 may regard that the second operation is carried out.

Here, the second operation is determined as follows. For example, in the case that the white list method is adopted as the first operation setting method, an operation, which explains a right reason why the first operation is not carried out even if a predetermined time has elapsed since a point of time when the second operation is carried out, is determined as the second operation. On the other hand, in the case that the black list method is adopted as the first operation setting method, a following operation is determined as the second operation: the operation that less likely to be performed even if a predetermined time has elapsed since the second operation is carried out. Specifically, it is assumed that the first operation is set out of a series of operations which are carried out, for example, in a service such as a sale of ticket or commutation ticket in the case that the information processing device 10 is an automatic ticket-selling machine of a train station. In this case, an operation of pressing a station staff calling button or an operation of pressing a displayed-language switching button is set as the second operation.

In the third exemplary embodiment, when the second operation is detected, the time measuring unit 130 resets the measured time, and restarts the time measurement from the beginning (starts measuring the time from the point of time when the second operation is detected). Here, in place of resetting the measured time, the time measuring unit 130 may suspend to measure the time, for a period of time equivalent to a time measured from a point of time when starting the measurement up to a point of time when detecting the second operation. Alternatively, the time measuring unit 130 may measure time since the detection of the second operation by subtracting a period of time measured from the start of the time measurement to the detection of the second operation from the current time measured.

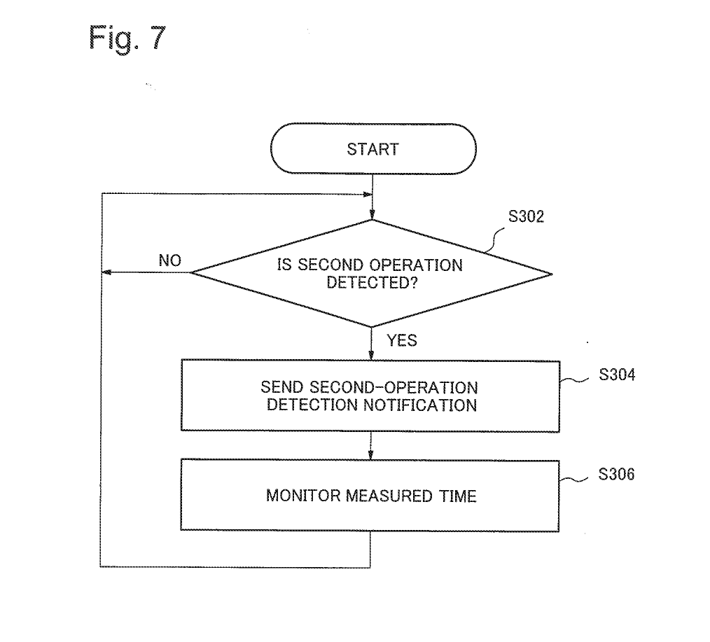

Hereinafter, an example of a process of the information processing device 10 in the third exemplary embodiment will be described with reference to FIG. 7. FIG. 7 is a flowchart showing the example of the process of the information processing device in the third exemplary embodiment.

Firstly, when the person detecting unit 110 detects presence of the person, the operation detecting unit 120 starts the monitor of the status of the operation. Next, the operation detecting unit 120 determines whether the first operation is carried out. In the third exemplary embodiment, the operation detecting unit 120 furthermore determines whether the second operation is carried out (Step S302). In the case of detecting the second operation, the operation detecting unit 120 sends the second-operation detection notification to the time measuring unit 130 (Step S304). On the other hand, in the case of not detecting the second operation in Step S302, the operation detecting unit 120 continues to monitor the status of the operation.

When the time measuring unit 130 receives the second operation detection notification, the time measuring unit 130 starts the time measurement from the point of time when detecting the second operation. Next, the time measuring unit 130 determines whether the measured time reaches the first time (monitor the measured time) (Step S306).

While the time measuring unit 130 carries out the time measurement, the operation detecting unit 120 repeats a process of Step S302 and its following steps. In the case of detecting the first operation during carrying out the process, the operation detecting unit 120 ends the process of detecting the second operation. Moreover, in the case that the time measuring unit 130 detects that the measured time reaches the first time, the operation detecting unit 120 ends the process of detecting the first operation and the second operation.

Hereinafter, an effect of the third exemplary embodiment will be described. In the third exemplary embodiment, the second operation is set. In the case that the second operation is detected, the time measuring unit 130 resets the measured time, and starts measuring the time from the point of time when the second operation is detected. In the case that the white list method is adopted as the first operation setting method, the above mentioned configuration prevents that the notification unit 140 sends the notification information by mistake though there is a right reason why the first operation is not carried out.

Moreover, in the third exemplary embodiment, when the second operation is carried out, the time measuring unit 130 restarts the time measurement. As a result, a period from the point of time when the person detecting unit 110 detects the person to the point of time when the measured time output by the time measuring unit 130 reaches the first time, becomes long. In other words, a time when the information processing device 10 monitors the user becomes long. Therefore, the information processing device 10 of the third exemplary embodiment can prevent failure in detecting the anomalous operation which is carried out by the user.

### Fourth Exemplary Embodiment

Hereinafter, a fourth exemplary embodiment according to the present invention will be described. Here, in the explanation on the fourth exemplary embodiment, portions of a configuration of the fourth exemplary embodiment, which are the same as the ones of the first to the third exemplary embodiments, are assigned the same reference numerals, and explanations on the same portion are omitted.

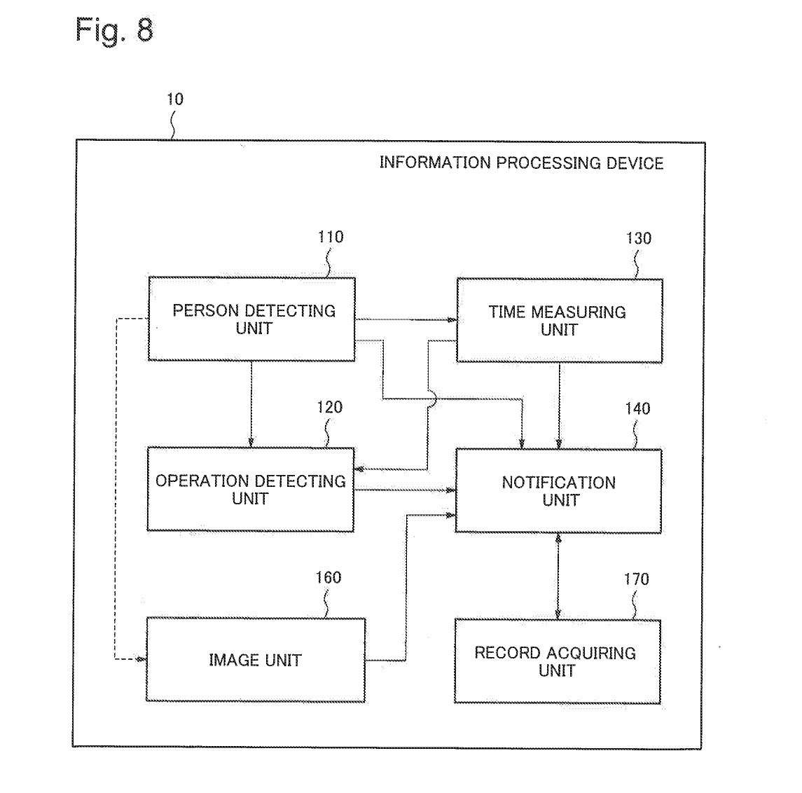

FIG. 8 is a block diagram showing a functional configuration of an information processing device in the fourth exemplary embodiment. The information processing device 10 of the fourth exemplary embodiment furthermore includes an image unit 160 and a record acquiring unit 170 in addition to any one of the configurations of the first to the third exemplary embodiments.

The image unit 160 includes, for example, a camera, and has a function of generating image data which captures the neighborhood of the information processing device 10. While the information processing device 10 is operation, the image unit 160 may continue to capture the neighborhood of the information processing device 10. Alternatively, for example, by use of the detection information which is output from the person detecting unit 110, the image unit 160 may start capturing the neighborhood of the information processing device 10 at timing when the person detecting unit 110 detects presence of the person. Moreover, time information, which indicates a time when capturing the neighborhood, is associated with the image data which is generated by the image unit 160.

Here, it is preferable that the image unit 160 (camera) is installed so as to be able to acquire the image data which makes it easy to check the operation carried out by the person. Specifically, for example, it is preferable that the image unit 160 is installed so as to be able to capture an upper part of the information processing device 10 which includes an operation unit (for example, touch panel).

In the fourth exemplary embodiment, when the notification unit 140 outputs the notification information to the external device, the image data generated by the image unit 160 is embedded in the notification information, and the notification information including the image data is output. Alternatively, the image data generated by the image unit 160 may be output by the notification unit 140 at timing which is different from the timing when the notification information is output.

Here, the image unit 160 may be installed as a dedicated device which captures the anomalous operation carried out by the user, and may be a shared device which also another function uses. Moreover, the image data generated by the image unit 160 may be a motion picture, or a still picture which is captured discretely at a predetermined time interval. Furthermore, a plurality of the image units 160 may be included by the information processing device 10. In this case, for example, the notification unit 140 may embed the image data, which is output by all of or a part of the plural image units 160, in the notification information, and may output the notification information including the image data.

The record acquiring unit 170 extracts all operation logs which are related to the operation carried out to the information processing device 10 by the person who is detected by the person detecting unit 110, or operation logs which are related to a predetermined specific operation, and acquires the extracted logs as an operation record. Here, in the case of extracting the operation logs which are related to the specific operation, the record acquiring unit 170 selects the operation logs, which are related to the specific operation, from a storage unit which stores the operation logs, and acquires the selected operation logs as the operation record. Alternatively, the record acquiring unit 170 may extract the operation logs, which are related to the specific operation, after acquiring all of the operation logs, and may acquire the extracted logs as the operation record. Moreover, time information which indicates an operation time is associated with the operation record which the record acquiring unit 170 acquires.

In the fourth exemplary embodiment, when the notification unit 140 outputs the notification information to the external device, as the operation record, the notification information includes both of the image data which is captured by the image unit 160, at least, at a period of time shown in the following, and the operation log which is acquired by the record acquiring unit 170. The period from the point of time when the first time elapses since presence of the person has been detected or the period of time when the first operation is detected to the point of time which goes back by the second time.

Here, the second time is a period of time assumed to be long enough to capture the anomalous operation or the anomalous action of the person who is detected by the person detecting unit 110. The second time is set, for example, on the basis of a relation between a time elapse from the point of time when the person is detected by the person detecting unit 110, and a probability that the anomalous operation is carried out, or the like. Specifically, the second time is set, for example, in such a way that a probability of detecting the anomalous operation is equal to or higher than a predetermined threshold value after a point of time that corresponds to the second time. Alternatively, the second time may be set so as to go back to a point of time when the person is detected by the person detecting unit 110 to ensure that the point of time when the anomalous operation is carried out is included. Information on the second time is stored in advance, for example, by a storage unit of the information processing device 10 such as a hard disc device or a memory, or by an external storage device which is communicably connected with the information processing device 10.

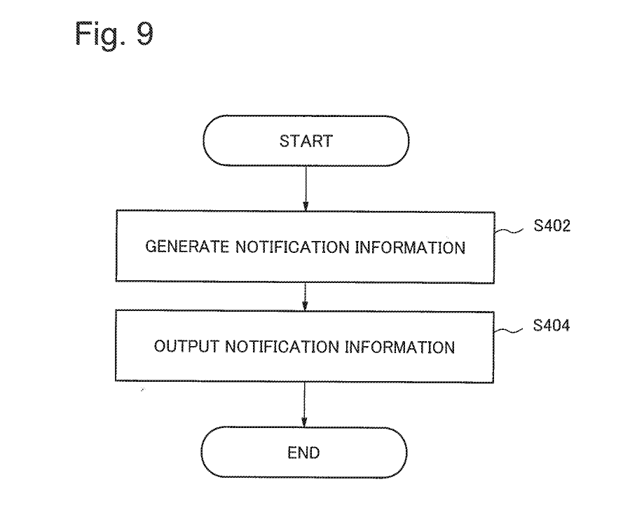

Hereinafter, an example of a process of the information processing device 10 in the fourth exemplary embodiment will be described with reference to FIG. 9. FIG. 9 is a flowchart showing the example of the process of the information processing device 10 in the fourth exemplary embodiment. Here, the process shown in FIG. 9 is a process which the notification unit 140 carries out.

Here, a period from the point of time when the first time elapses or the point of time when the first operation is detected to the point of time going back by the second time from the point of time when the first time elapses or the point of time when the first operation is detected, is denoted as a verification period of time.

On the basis of the image data generated by the image unit 160 and the time information associated with the operation log acquired by the record acquiring unit 170, the notification unit 140 generates the notification information including the image data and the operation log, which are generated at the verification period of time, as the operation record (Step S402). Next, the notification unit 140 outputs the generated notification information to the external device (Step S404).

Here, in place of the above mentioned example, the notification unit 140 may alternatively output the notification information which includes either the image data generated by the image unit 160 or the operation log acquired by the record acquiring unit 170 as the operation record in the verification period of time.

Hereinafter, an effect which is acquired from the fourth exemplary embodiment will be described.

The information processing device 10 of the fourth exemplary embodiment has the configuration which can make the notification information, which is output from the notification unit 140, include the operation record generated at the verification period of time. Therefore, by checking the notification information which is received by the external device, the service provider can precisely grasp, for example, what kind of problem the person who is detected by the person detecting unit 110 is confronted with.

### Another Exemplary Embodiment

Hereinbefore, the exemplary embodiments according to the present invention have been described with reference to the drawings. However, these exemplary embodiments merely exemplify the present invention, and the present invention can have various configurations other than the above mentioned configurations of the exemplary embodiments.

For example, there is a case that the information processing device 10 furthermore includes a communication device such as an intercommunication system which is directly connected with a support desk. In this case, a status in which the user uses the communication device is a status that the user receives support from the service provider. Accordingly, it is preferable for the time measuring unit 130 to suspend the time measurement in the case of detecting that the communication device (intercommunication system or the like) is used. The above mentioned configuration enables to prevent a problem that, though the user does not carry out the anomalous operation or the anomalous action, the notification unit 140 sends the notification information notifying the anomalous operation or the anomalous action to the external device by mistake.

Moreover, for example, there are some cases that the user is in a state that the user cannot use the information processing device 10. Specifically, one of the cases is, for example, that a screen of a display unit of the information processing device 10 is a screen which is operated by the service provider side (for example, a management screen of the information processing device 10 or the like). Another case is that the information processing device 10 is out of service because the information processing device 10 is in a state of suffering from a fault, receiving a maintenance service or the like. In consideration of these cases, the information processing device 10 may have a configuration, for example, that a notification, which notifies that the user is in a state of being unable to use the information processing device 10, is provided to the time measuring unit 130 while the user is in such state. In this case, the time measuring unit 130 may have a configuration that, even if the person detecting unit 110 detects presence of the person, the time measuring unit 130 does not start the time measurement at a period of time when receiving the notification. The above mentioned configuration enables to prevent a problem that, though the user does not carry out the anomalous operation or the anomalous action, the notification unit 140 sends the notification information notifying the anomalous operation or the anomalous action to the external device by mistake.

An order of carrying out the processes which are described in each of the first to fourth exemplary embodiments is a mere example and may be changed as far as any problem does not occur in the contents of each of the exemplary embodiments. Furthermore, while the self-service terminal is exemplified as the information processing device in the first exemplary embodiment and the like, the present invention is applicable to not only the self-service terminal but also an information processing device such as a general purpose PC or the like.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2013-271903, filed on Dec. 27, 2013, the disclosure of which is incorporated herein in its entirety by reference.

A part of or a whole of the exemplary embodiment mentioned above can be described like the following Supplementary Note, but is not limited to the following Supplementary Note.

<Supplementary Note 1>

An information processing device, includes:

person detecting means for detecting presence of a person in the neighborhood of the information processing device;

operation detecting means for detecting a first operation;

timer means for determining elapse of a first time depending on detection of the person; and

information notifying means for outputting notification information to an external device based on a status of monitoring elapse of the first time, and a status of detecting the first operation.

<Supplementary Note 2>

The information processing device according to Supplementary Note 1, further includes:

service information acquiring means for acquiring service identifying information for identifying a service carried out by an operation of the person,

wherein the operation detecting means detects the first operation, which corresponds to service identifying information acquired by the service information acquiring means, out of the plural first operations each of which is defined per the service in advance.

<Supplementary Note 3>

The information processing device according to Supplementary Note 1 or Supplementary Note 2, wherein the operation detecting means detects an operation pattern which includes plural kinds of operations including the first operation.

<Supplementary Note 4>

The information processing device according to any one of Supplementary Note 1 to Supplementary Note 3, wherein the operation detecting means furthermore detects whether a second operation is carried out before the first operation is detected, and

wherein the timer means controls the status of monitoring elapse of the first time depending on the status of detecting the second operation.

<Supplementary Note 5>

The information processing device according to any one of Supplementary Note 1 to Supplementary Note 4, wherein the information notifying means embeds information, which the information processing device acquires at a point of time which goes back by a second time from a point of time when the first time elapses or a point of time when the first operation is detected, in the notification information, and outputs the notification information which includes the embedded information.

<Supplementary Note 6>

The information processing device according to Supplementary Note 5, wherein the information notifying means embeds information, which the information processing device acquires at a period from the point of time going back by the second time to a point of time when the person detecting means does not detect a person, in the notification information, and outputs the notification information which includes the embedded information.

<Supplementary Note 7>

The information processing device according to any one of Supplementary Note 1 to Supplementary Note 6, wherein the notification information includes at least any one of image data of the person generated by an image means, and at least a part of records on operations which are carried out by the person.

<Supplementary Note 8>

An information processing method in which a computer:

detecting presence of a person in the neighborhood of the computer;

detecting a first operation;

monitoring elapse of a first time depending on detection of the person; and

outputting notification information to an external device based on a status of monitoring elapse of the first time, and a status of detecting the first operation.

<Supplementary Note 9>

The information processing method according to Supplementary Note 8, wherein the computer furthermore acquires service identifying information which identifies a service carried out by an operation of a person, and

wherein the computer detects the first operation corresponds to the acquired service identifying information, out of the plural first operations each of which is defined per the service in advance.

<Supplementary Note 10>

The information processing method according to Supplementary Note 8 or Supplementary Note 9, wherein the computer detects an operation pattern which includes plural kinds of operations including the first operation.

<Supplementary Note 11>

The information processing method according to any one of Supplementary Note 8 to Supplementary Note 10, wherein the computer furthermore detects whether a second operation is carried out before the first operation is detected, and

wherein the computer controls the status of monitoring elapse of the first time according to the status of detecting the second operation.

<Supplementary Note 12>

The information processing method according to any one of Supplementary Note 8 to Supplementary Note 11, wherein the computer embeds information, which the information processing device acquires at a point of time which goes back by a second time from a point of time when the first time elapses or a point of time when the first operation is detected, in the notification information, and outputs the notification information which includes the embedded information.

<Supplementary Note 13>

The information processing method according to Supplementary Note 12, wherein the computer embeds information, which the information processing device acquires at a period from the point of time going back by the second time to a point of time when the person detecting means does not detect a person, in the notification information, and outputs the notification information which includes the embedded information.

<Supplementary Note 14>

The information processing method according to any one of Supplementary Note 8 to Supplementary Note 13, wherein the notification information includes at least any one of image data of the person which is generated by an image means, and at least a part of records on operations which are carried out by the person.

<Supplementary Notes 15>

A program for making a computer work as:

person detecting means for detecting presence of a person in the neighborhood of the computer;

operation detecting means for detecting a first operation;

timer means for determining elapse of a first time depending on detection of the person; and

information notifying means for outputting notification information to an external device based on a status of monitoring elapse of the first time, and a status of detecting the first operation.

<Supplementary Note 16>

The program according to Supplementary Note 15, wherein the program furthermore makes the computer work as a service information acquiring means which acquires service identifying information for identifying a service carried out by an operation of the person, and

Wherein the program makes the computer detect the first operation, which corresponds to service identifying information acquired by the service information acquiring means, out of the plural first operations, each of which is defined per the service in advance, by use of the operation detecting means.

<Supplementary Note 17>

The program according to Supplementary Note 15 or Supplementary Note 16, wherein the program makes the computer detect an operation pattern, which includes plural kinds of operations including the first operation, by use of the operation detecting means.

<Supplementary Note 18>

The program according to any one of Supplementary Note 15 to Supplementary Note 17, wherein the program makes the computer furthermore detect whether a second operation is carried out before the first operation is detected by use of the operation detecting means, and

wherein the program makes the computer control the status of monitoring elapse of the first time depending on the status of detecting the second operation by use of the timer means.

<Supplementary Note 19>

The program according to any one of Supplementary Note 15 to Supplementary Note 18, wherein the program makes the computer embed information, which the information processing device acquires at a point of time that goes back by a second time from a point of time when the first time elapses or a point of time when the first operation is detected, in the notification information, and output the notification information, which includes the embedded information, by use of the information notifying means.

<Supplementary Note 20>

The program according to Supplementary Note 19, wherein the program makes the computer embed information, which the information processing device acquires at a period from the point of time going back by the second time to a point of time when the person detecting means does not detect a person, in the notification information, and output the notification information, which includes the embedded information, by use of the information notifying means.

<Supplementary Note 21>

The program according to any one of Supplementary Note 15 to Supplementary Note 20, wherein the notification information includes at least any one of image data of the person generated by an image means, and at least a part of records on operations which are carried out by the person.

### REFERENCE SIGNS LIST

10 information processing device
11 CPU
12 memory
14 communication device
110 person detecting unit
120 operation detecting unit
130 time measuring unit
140 notification unit
150 acquisition unit
160 image unit
170 record acquiring unit

What is claimed is:

1. An information processing device, comprising:
a person detecting unit that detects presence of a person in a neighborhood of own device;
a operation detecting unit that detects, as a first operation, that a predetermined normal operation or a predetermined anomalous operation is carried out;
a time measuring unit that starts a time measurement at a predetermined timing after detecting presence of the person in the neighborhood of own device; and
a notification unit that outputs notification information to an external device that is communicably connected, when the normal operation is set as the first operation and this first operation is not detected before time measured by the time measuring unit reaches a predetermined first time or when the anomalous operation is set as the first operation and this first operation is detected before the time measured by the time measuring unit reaches the first time, the notification information notifying an occurrence of a status requiring a check.

2. The information processing device according to claim 1, further comprising
acquisition unit that acquires service identifying information that identifies kind of service being performed by own device,
wherein the first operation is set for each of a plurality of kinds of the services available depending on content thereof and
the operation detecting unit operates based on the first operation associated with the service identifying information acquired by the acquisition unit.

3. The information processing device according to claim 1, wherein the first operation is an operation pattern including a plurality of operations related to each other.

4. The information processing device according to claim 1, wherein the operation detecting unit further includes a function to detect that a predetermined second operation is carried out in a time period from detection of detecting presence of a person in a neighborhood of own device of the person in the neighborhood of own device to detection of the first operation, and
Wherein, when execution of the second operation is detected, the time measuring unit includes a function to reset the time measured and restart the time measurement after the execution of the second operation.

5. The information processing device according to claim 1, further comprising:
a record acquiring unit that acquires an operation log representing contents of operation as an operation record,
wherein the notification unit outputs the notification information including the operation record in a period from a point of time when the time measured by the time measuring unit reaches the first time or a point of time when the operation detecting unit detects the first operation to a point of time going back by a predetermined second time.

6. The information processing device according to claim 1, wherein the notification unit acquires image data output by an imaging device which can capture an operating status of own device as an operation record, and outputs the notification information including the operation record in a period from a point of time when the time measured by the time measuring unit reaches the first time or a point of time when the operation detecting unit detects the first operation to a point of time going back by a predetermined second time.

7. The information processing device according to claim 5, wherein the notification unit further outputs the operation record including the operation carried out until a person is not detected by the person detecting unit.

8. An information processing method, comprising:
by computer,
detecting presence of a person in a neighborhood of own device;
detecting, as a first operation, that a predetermined normal operation or a predetermined anomalous operation is carried out;
starting a time measurement at predetermined timing after detected presence of the person in the neighborhood of own device; and
outputting notification information to an external device that is communicably connected, when the normal operation is set as the first operation and this first operation is not detected before time measured reaches a predetermined first time or when the anomalous operation is set as the first operation and this first operation is detected before the time measured reaches the first time, the notification information notifying an occurrence of a status requiring a check.

9. A storage medium storing a non-transitory computer program that causes a computer to execute:
processing for detecting presence of a person in a neighborhood of own device;
processing for detecting, as a first operation, that a predetermined normal operation or a predetermined anomalous operation is carried out;
processing for starting a time measurement at a predetermined timing after detecting presence of the person in the neighborhood of own device; and
processing for outputting notification information to an external device that is communicably connected, when the normal operation is set as the first operation and this first operation is not detected before time measured reaches a predetermined first time or when the anomalous operation is set as the first operation and this first operation is detected before the time measured reaches the first time, the notification information notifying an occurrence of a status requiring a check.
